(19) United States
(12) Patent Application Publication
(10) Pub. No.: US 2008/0120183 A1
(43) Pub. Date: May 22, 2008

(54) SYSTEMS AND METHODS FOR COMMUNICATING PERSONAL INFORMATION

(76) Inventor: Sung Park, Newton, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/871,512

(22) Filed: Oct. 12, 2007

Related U.S. Application Data
(60) Provisional application No. 60/829,245, filed on Oct. 12, 2006.

(51) Int. Cl. G06Q 30/00; H04Q 7/20

(52) U.S. Cl. 705/14; 455/466

(57) ABSTRACT

In embodiments of the present invention improved capabilities are described for an information facility, where the information facility enables a first user to transmit personal information to a second user. The information facility may receive a first text message from an origin, and transmit a second text message to a destination. The first text message may contain information related to the destination, the origin may be associated with the personal information, and the second text message may contain the personal information. Additional communications with the origin and the destination may be associated with contextual advertisements, and may also enable the exchange of content associated with social networks. In addition, parental control may provide restrictions in association with the second text message.

### CROSS-REFERENCE TO RELATED APPLICATIONS

This application claims the benefit of the following provisional application, which is hereby incorporated by reference in its entirety:

U.S. provisional patent application Ser. No. 60/829,245, filed Oct. 12, 2006, and entitled “SYSTEMS AND METHODS FOR COMMUNICATING PERSONAL INFORMATION”.

### BACKGROUND

1. Field

The present invention relates to the field of personal information management, and specifically to the distribution of personal information via an SMS-based platform.

2. Description of the Related Art

SMS stands for “short message service” and is part of the Global System for Mobile Communications (GSM). SMS is available on most if not all cell phones currently in service. Conversely, other data communications services, such as IrDA, Internet protocol, and so on are not nearly as widely implemented. Thus, SMS is perhaps the most common way of communicating information between cell phones.

Many people are within reach of their cell phones at all times. This may be especially true with young and/or urban people.

In circumstances where people are becoming acquainted, it is customary for people to exchange personal information, such as and without limitation name, address, email address, MySpace URL, IM handle, phone number, and so on. To ease the transfer of personal information in such circumstances, businesspeople may equip themselves with business cards, Blackberry devices, handheld computers, and so forth.

Young people, on the other hand, may simply have their cell phones and not the personal-information-exchange equipment of a businessperson. Unfortunately, typing personal information into a cell phone can be time consuming, tedious, and error prone.

A need, therefore, exists to enable young people to exchange personal information using their cell phones.

### SUMMARY

The present invention provides systems and methods for communicating personal information. An information facility receives a first communication from a first user. In response to this communication, the information facility transmits a second communication to a second user. Both the first and second communication may be SMS communications. The first communication may comprise a command, wherein the command instructs the information facility to transmit the second communication to the second user. The second communication may comprise personal information of the first user. Optionally, the second communication may further comprise an advertisement. Optionally, the information facility may further transmit a third communication to the first user, wherein this communication is also in response to the first communication and contains an advertisement. In any case, the information facility may, from time to time, receive and store the personal information from the first user. Additional communications with the origin and the destination may enable the exchange of content associated with social networks. In addition, parental control may provide restrictions in association with the second text message.

In embodiments, the contextual advertisements may be associated with user preference, where the user preference may be selectable, and may be associated with a theme such as sports, fashion, consumer goods, entertainment, travel, and the like. In addition, the theme may be selectable to be excluded, and selections may be made at the time of the first text message. In embodiments, the advertisement may be provided in lieu of a payment, such as associated with a subscription cost, an additional service, an additional personal profile, an additional allocation of memory, a discount, and the like. The contextual advertisement may also be associated with the information in the first text message. In addition, the contextual advertisement to the destination may be associated with directions for setting up an account.

In embodiments, the parental control restrictions may be associated with at least one of an inclusion list, and exclusion list, an age restriction, a gender, and the like. Parental control may be enabled through a user action, such as by generating one of an inclusion or exclusion lists, specifying a restriction in association with age or gender, or the like.

In embodiments, social content may include a friends list, a favorites list, an image, a video, music, personal information, a personal interest, a comment entry, a bulletin board entry, and the like. Updating may include information not included in the personal information of the second text message. In addition, updating may be in association with a user other than the origin or the destination.

The information facility may be associated with additional systems and methods, including without limitation those relating to authentication, verification, a code, an advertisement, caller-ID, or the like.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a block diagram of systems and methods of the present invention.

### DETAILED DESCRIPTION

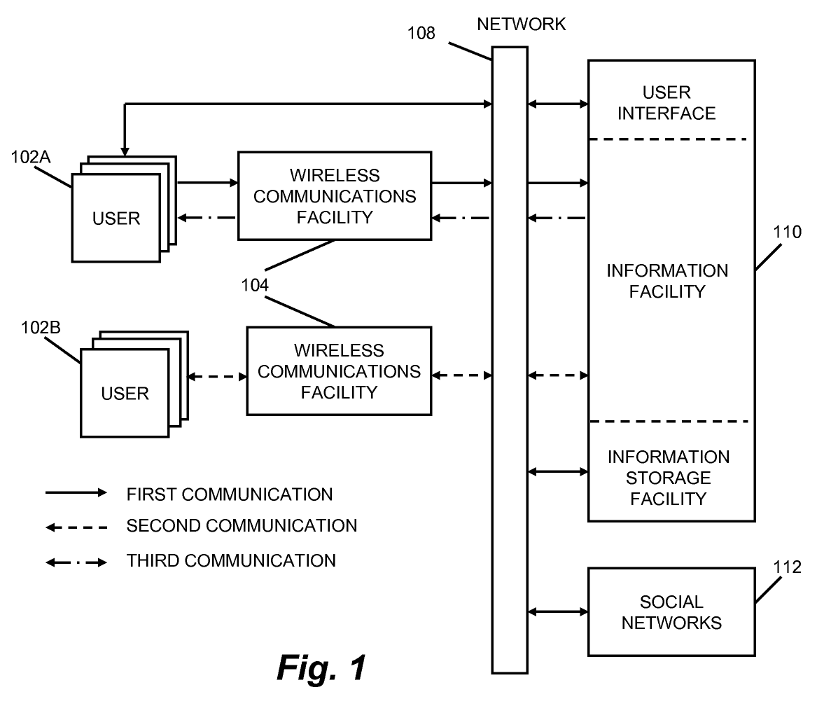

The present invention may relate to a communication of personal information from a first user to a second user via an information facility. Referring now to FIG. 1, a first user 102A may use a wireless communications facility 104 to initiate a first communication to an information facility 110. The first communication may encompass an instruction from the first user 102A to the communication facility 110. The instruction may direct the information facility 110 to transmit a second communication, which comprises the first user's personal information to a wireless communications facility 104 of a second user 102B. To initiate the first communication, the first user 102A may employ a wireless communications facility 104 that incorporates a short message service (SMS). In embodiments, the first and second communications may comprise a text message.

In advance of initiating the first communication, the first user 102A may submit their personal information to the information facility 110. From time to time, the first user 102A may submit updates to their personal information. In any case, the information facility 110 may store the personal information for later use. In embodiments, the first user 102A may submit their personal information and/or updates thereto via a browser-enabled facility.

Communications between users 102A, 102B and the information facility 110 may be enabled by a network 108, which may comprise a cellular telephone network, an internetwork, a local area network, a metropolitan area network, a wide area network, and the like. Access to the network 108 and/or the information facility 110 may be controlled in association with systems and methods of authentication, password protection, verification of a user's telephone number, caller-ID, and the like.

Communications that are transmitted by the information facility 110 may comprise one or more advertisements. Optionally, the information facility 110 may be adapted to honor a user preference relating to the types of advertisements the information facility 110 communicates. In embodiments, the information facility 110 may provide a user interface for accepting and/or modifying the user preference.

The information facility 110 may receive the first communication from the first user 102A. In response to this communication, the information facility 110 may transmit a second communication to the second user 102B. In embodiments, both the first and second communication may be SMS communications. The first communication may comprise a command, wherein the command instructs the information facility to transmit the second communication to the second user. The second communication may comprise personal information of the first user 102A. Optionally, the second communication may further comprise an advertisement. Optionally, the information facility 110 may further transmit a third communication to the first user 102A, wherein this communication is also in response to the first communication and contains an advertisement. In embodiments, the third communication may be an SMS communication. In any case, the information facility 110 may, from time to time, receive and store the personal information from the first user.

Embodiments of the present invention that incorporate SMS communications may be compatible with most, if not all, digital cellular telephones currently in service. It will be appreciated that these embodiments may also be compatible with PocketPCs, handheld computers, personal digital assistants, or any and all digital devices that incorporate SMS. It will still further be appreciated that an SMS gateway may enable communications from a device that is not SMS enabled to and/or from the information facility 110. Such a gateway may translate one or more types of non-SMS digital communications into SMS communications. For example and without limitation, a Web-to-SMS gateway that is operatively coupled to the Internet may allow users to send and/or receive text messages via a Web browser. Generally, the wireless communications facility 104 may comprise a digital cellular telephone, a PocketPC, a handheld computer, a personal digital assistant, a digital device that incorporates SMS, a digital communications facility that is in communication with an SMS gateway, a web browser, and so on.

SMS may permit the sending of short text messages between mobile phones, other handheld devices, and even landline telephones. SMS technology may also used to deliver other content. On mobile devices, SMS may be used to order things from vending machines, and to receive content from websites, including content such as business addresses and phone numbers, news alerts, ringtones, logos and financial information.

SMS messages may be sent via a store-and-forward mechanism to a Short Message Service Center (SMSC), which will attempt to send the message to the recipient. If a destination SMS device is not reachable, the SMSC may save the message. Later when the destination SMS device is later reachable, the SMSC may retry the delivery process. SMS may support both messages originating from and terminating at a mobile device. In embodiments, any of a plurality of protocols may be used for sending SMS messages, including TCP/IP. In embodiments, a long SMS message may be broken up and sent as segments (i.e. a set of shorter SMS messages), which may or may not be concatenated at a destination device to reconstitute the longer message.

In embodiments, a user 102A of the invention may be a person who wishes to provide an electronic form of personal information to another user 102B through a wireless communication facility 104. In embodiments, this exchange of information may serve the function of an electronic business card. In embodiments, the users 102A, 102B may be in the same location or in different locations. This information may include a user's name, a mailing address, a personal e-mail address, MySpace account information, a business name, a business title, a business e-mail address, internet game information, personal preferences, calendar information, contact information, family information, or the like. In embodiments, a wireless communications facility 104 may be a cell phone, a cellular phone, a mobile phone, a 3G phone, a PDA, a mobile computer, a satellite phone, or the like.

In embodiments, a user 102A who wants to have personal information exchanged with another user 102B may have previously stored this information on an information facility 110. This information facility 110 may comprise a networked information storage facility. In embodiments, the information stored by the first users 102A and provided to the second users 102B, may be transferred across a network 108. In embodiments, the network 108 may be a wireless communications network, the Internet, a local network, a combination of these, or the like. The communications network 108 may be associated with a user's service provider that may provide access to the network 108, interconnectivity with other users, a gateway to the Internet, and the like. The information facility 110 may be accessible to the network 108 through the Internet, directly to a wireless communications network, or any combination thereof.

In embodiments, users 102 may have information stored on social network 112 sites, such as MySpace, Bebo, Facebook, and the like that they would like to update in association with the exchange of personal information. Updates to social networking 112 sites may include updates to a friend's list, a favorites list, images, music, music information, personal information, a personal interest, a comment entry, a bulletin board entry, and the like. In embodiments, users 102 may specify the degree to which they are willing to participate in an exchange of social network information, and they may specify this at the time of personal information exchange. For example, the user 102A initiating the download of personal information may indicate that they are willing to exchange social network information with the user 102B receiving the personal information, say through the text message that the user 102B receives. In embodiments, the user 102B may indicate that a mutual exchange of social network 112 information is acceptable, indicate that they are only willing to accept social network 112 information from the user 102A but unwilling to provide their personal information back to the user 102A, indicate that they are unwilling to participate in an exchange of social network 112 information, and the like. In embodiments, the indication may be provided by an SMS response to the message supplying them with the personal information from user 102A.

In embodiments, an indication by a user 102 to exchange social network information may be supplied to the information facility 110, where the information facility 110 may in turn communicate with the appropriate social networks 112 across the network 108. This communication may provide the requisite user 102 information to the social network 112 for the exchange of information. For instance, the information facility 110 may indicate that both users 102A, 102B are willing to exchange social network information, and this information, provided to the users' 102 social network 112, may grant the social network 112 facility permission to execute the update exchange. In embodiments, the updating may also include an exchange of information with individuals not participating in the exchange of personal information between the users 102, such as individuals listed on a user's friends list, favorite list, and the like. In embodiments, the updating may include information provided in the personal information exchange between users 102. Thus the present invention may provide a mechanism through which individuals may not only exchange personal information directly from user 102 to user 102, but may also an exchange of social network 112 information, form one user's 102 social network 112 page to the other user's 102 social network page.

In embodiments, the user 102A may register for use of the information facility 110. Registration may involve a fee for service. The fee for service may include a start-up fee, a monthly fee, a usage fee, or the like. Use of the information facility 110 may involve advertisements delivered during the information exchanges between users 102. In embodiments, the registering user 102A may have choices as to whether or not to enable advertisements in association with his use of the information facility. The user may be provided benefits as a result of enabling advertisements, for example, financial discounts or additional services. In embodiments, the user may be provided with a choice of what advertisements are provided in association with their service, or with a theme of the advertisements provided, such as sports, fashion, music, or the like. In embodiments, themes or specific advertising content may be chosen for exclusion by the user 102A, such as excluding advertisements for liquor or any and all other things that the user 102A finds objectionable. In embodiments, the advertisement may be contextual, that is, the associated advertisement may relate to elements of the information contained within the message, such as a geographic location, a job title, an interest, and the like. For example, if the information indicates a city or state of residence, the information facility 110 may associate a contextually-related advertisement to the message, such as that for a hotel in the indicated geographic area, an upcoming event in the geographic area, and the like. In another example, advertisements may be contextually related to content in the first or second text message, such as the type of personal information that is downloaded from the information facility 110; contextually related to content exchanged between social network accounts; contextually related to users' 102 SMS messaging in time proximity to the first and second text message; and the like. In embodiments, contextual-related advertisements may provide an improved match to the users' 102 personal interests, business interests, location, current activity, social network content, and the like.

In embodiments, the user 102A may be assigned a code that grants him access to the information facility 110. This code may be utilized by the user 102A when requesting a transfer of information to another user 102B. In initiating a transfer of information, the user may provide the information facility 110 with this code along with a phone number of the user 102B receiving the information. The information facility 110 may utilize caller-ID to authenticate and/or validate that the first user's 102A wireless communications facility 104 is being used to initiate the transfer. Caller-ID may additionally or alternatively be used to announce the identification of the sending user 102A to the receiving user 102B.

In embodiments, the user 102A may be able to update or modify his personal information on-line. Access may be provided from any browser-enabled facility (such as and without limitation a personal computer that is equipped with a web browser and an Internet connection). The user 102A may be able create multiple profiles or accounts in the information facility 110. For example, the user 102A may create one personal profile and one business profile. In embodiments, each profile may have their own access code, and advertisement preferences.

In embodiments, the receiving user may be provided an advertisement for the information facility 110, or directions on how to set up their own account.

In embodiments, the service provided by the information facility 110 may be optionally provided with parental control for users 102A under a specified age. Parental control may be associated with limiting the number or type of users 102B that the service is able to supply information. For example, a teenager may be limited to a predefined list, or to one sex or another, to users of a certain geographic area, or the like.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
receiving a first text message from an origin;
transmitting a second text message to a destination, wherein
the first text message contains an indication of the destination, the origin is associated with personal information, and the second text message contains the personal information; and
transmitting a contextual advertisement to at least one of the origin and destination.

2. The method of claim 1, wherein the contextual advertisement is associated with a user preference.

3. The method of claim 2, the user preference is selectable.

4. The method of claim 2, the user preference is associated with a theme, including at least one of sports, fashion, consumer goods, entertainment, and travel.

5. The method of claim 4, the theme is an excluded theme.

6. The method of claim 4, the theme is selectable by the user at the time of the first text message.

7. The method of claim 1, the contextual advertisement is in lieu of a payment.

8. The method of claim 7, the payment is associated with a subscription cost.

9. The method of claim 7, the payment is associated with an additional service.

10. The method of claim 9, the additional service is an additional personal profile.

11. The method of claim 9, the additional service is an additional memory allocation.

12. The method of claim 7, the payment is associated with a discount.

13. The method of claim 1, the contextual advertisement is associated with content from the first text message.

14. The method of claim 1, the contextual advertisement to the destination is associated with directions for setting up an account.

15. A method comprising:
receiving a first text message from an origin;
transmitting a second text message to a destination, wherein
the first text message contains an indication of the destination, the origin is associated with personal information, and the second text message contains the personal information; and
restricting the transmitting of the second text message in association with parental control.

16. The method of claim 15, the restricting is associated with at least one of an inclusion list, an exclusion list, an age restriction, and a gender.

17. The method of claim 15, parental control is enabled through a user action.

18. The method of claim 17, the user action generates one of an inclusion or exclusion list.

19. The method of claim 17, the user action specifies one of a restriction associated with age and gender.

20. A method comprising:
receiving a first text message from an origin;
transmitting a second text message to a destination, wherein the first text message contains an indication of the destination, the origin is associated with personal information, and the second text message contains the personal information; and
updating social network content in association with at least one of the origin and destination.

21. The method of claim 20, the social content includes at least one of a friends list, a favorites list, an image, a video, music, personal information, a personal interest, a comment entry, and a bulletin board entry.

22. The method of claim 20, the step of updating is in association with a user other than the origin or the destination.

23. The method of claim 20, the step of updating includes an exchange of social network content not included in the personal information.

24. A system comprising:
an information facility that is adapted to receive a first text message from an origin and to transmit a second text message to a destination, wherein the first text message contains an indication of the destination, the origin is associated with personal information, and the second text message contains the personal information; and
a transmitting facility to transmit a contextual advertisement to at least one of the origin and destination.

25. A system comprising:
an information facility that is adapted to receive a first text message from an origin and to transmit a second text message to a destination, wherein the first text message contains an indication of the destination, the origin is associated with personal information, and the second text message contains the personal information; and
an updating facility to update social network content in association with at least one of the origin and destination.
